(19) United States
(12) Patent Application Publication
(10) Pub. No.: US 2021/0214899 A1
(43) Pub. Date: Jul. 15, 2021

(54) ADHESIVE AND MULTI PLY PULP PRODUCT BONDED WITH THE ADHESIVE

(71) Applicant: MYBIOMASS SDN. BHD., Cyberjaya, Selangor (MY)

(72) Inventors: Kimberly NELSON, Atlanta, GA (US); Puvaneswari RAMASAMY, Cyberjaya (MY); Sivasankari RANGANATHAN, Cyberjaya (MY)

(73) Assignee: MYBIOMASS SDN. BHD., Cyberjaya, Selangor (MY)

(21) Appl. No.: 17/058,118

(22) PCT Filed: Feb. 25, 2019
(86) PCT No.: PCT/MY2019/000007

§ 371 Date: Nov. 23, 2020

(30) Foreign Application Priority Data
May 24, 2018 (MY) PI 2018702006

(51) Int. Cl. D21H 27/32; C09J 7/21; C08L 1/02; C08L 3/02; D21H 17/29

(52) U.S. Cl. CPC D21H 27/32; C09J 7/21; C08L 1/02; C09J 2401/00; D21H 17/29; C09J 2403/00; C08L 2205/16; C08L 3/02

(57) ABSTRACT

The present invention relates to an adhesive comprising of starch and nanocellulose. The adhesive has a nanocellulose concentration of between 0.1 wt % to 12.0 wt % and a starch concentration of between 01 wt % to 12.0 wt % based on the overall weight of the adhesive. The adhesive is produced by combining the nanocellulose and starch at a prescribed ratio and is applied on the surfaces of the paper product to be joined. The present invention also relates to a multi ply pulp product having at least two plies of pulp product joined using an adhesive wherein the adhesive has a nanocellulose concentration of 0.1 wt % to 12.0 wt % and a starch concentration of 0.1 wt % to 12.0 wt % based on the overall weight of the multi ply pulp product.

### FIELD OF INVENTION

The invention relates an adhesive and a multi ply pulp product wherein the adhesive and pulp product contain starch and nanocellulose obtained from biomass resources.

### BACKGROUND OF INVENTION

One of the many uses or applications of cellulosic nanomaterials is the use of nanocellulose to enhance or Improve the strength and quality of various paper products. Nanocellulose may be Introduced to conventional pulp composition during manufacturing to improve the properties of the pulp and the products that are produced thereof.

The nanocellulose may be derived from various biomass resources or feedstock such as agricultural wastes, natural fibres and many more. The nanocellulose are obtained from these biomass resources by reducing the size of biomass fibers via a chemical and/or mechanical process. Besides the use of nanocellulose to enhance the strength of the paper products, starch is commonly used in the papermaking industry for the same purpose.

Starch applications in the paper industry is not limited to wet-end starch to increase strength but also as an adhesive to increase ply bond strength, as an adhesive between corrugating medium and linerboard, as a surface coating to increase structural strength and stiffness, among other uses.

Starch is used to Improve adhesion or ply bond between the fiber layers contained in multi ply sheets. Many paperboard grades are multi ply as well as tissue and other paper grades. For example, in paperboard, the multi ply process offers the benefit of producing higher basis weight grades and the outer layer may be made with a furnish that best meets the requirements of the sheet surface, while the inner part of the sheet would be made of a furnish that meets other needs.

Multi ply sheets tend to delaminate easily as each of the individual ply may break away from each other. The ply bond, which is the strength of the bond between each individual sheet, is essential in determining the quality of the paperboard, natural, uncooked starch slurry is usually used to Improve the strength of the ply bond of the paperboard by spraying or applying it between at least two sheets. The plies bind together when the uncooked starch is gelatinized while the paperboard is being dried, higher ply bond strength for pulp-based products such as tissue and paperboard may allow mill to enter higher quality markets. However, with the increased use of recycled fibers, the strength of the ply bonds will have to be improved and the use of starch may not be sufficient. Thus, there is a need for a new method to improve on the quality of the ply bond especially with the increased use of recycled fibers,

### SUMMARY OF THE INVENTION

The present invention in some variations relates to a process of producing a multi ply pulp product having at least two single ply pulp products joined to each other using an adhesive, wherein the process includes the steps of:—a. preparing at least a first and a second single ply pulp products by combining a starting pulp and a first mixture of nanocellulose and starch; b. preparing the adhesive by mixing a first mixture of nanocellulose and starch; c. interposing the adhesive between the first single ply pulp product and the second single ply pulp product; and d. joining the first and second single ply pulp products containing the adhesive interposed there between, producing a multi ply pulp product; wherein the nanocellulose and starch concentrations in the multi ply pulp product has an overall weight of 0.1 wt % to 12.0 wt % each, wherein the nanocellulose and starch concentrations in the adhesive in step b has an overall weight of 0.1 wt % to 12.0 wt % each.

Other features and advantages will be apparent from the following description and the claims.

### DETAIL DESCRIPTION OF THE INVENTION

The present invention in some variations relates to a process of producing a multi ply pulp product having at least two single ply pulp products joined to each other using an adhesive, wherein the process includes the steps of:—a. preparing at least a first and a second single ply pulp products by combining a starting pulp and a first mixture of nanocellulose and starch; b. preparing the adhesive by mixing a first mixture of nanocellulose and starch; c. interposing the adhesive between the first single ply pulp product and the second single ply pulp product; and d. joining the first and second single ply pulp products containing the adhesive interposed there between, producing a multi ply pulp product; wherein the nanocellulose and starch concentrations in the multi ply pulp product has an overall weight of 0.1 wt % to 12.0 wt % each, wherein the nanocellulose and starch concentrations in the adhesive in step b has an overall weight of 0.1 wt % to 12.0 wt % each.

In an embodiment, the present invention relates to a multi ply pulp product having at least two single ply pulp Intermediate layers joined to each other using an adhesive wherein the adhesive has a nanocellulose concentration of 0.1 wt % to 12.0 wt % and a starch concentration of 0.1 wt % to 12.0 wt % based on the overall weight of the multi ply pulp product. The use of nanocellulose and starch in a prescribed ratio or percentage in the adhesive enhances and improves the strength of the ply bond when used to join the multiple plies of a paper product.

In an embodiment, the present invention relates to a process for producing a multi ply pulp product wherein the process includes the steps of providing starting pulp, providing nanocellulose and providing starch wherein the nanocellulose concentration is of 0.1 wt % to 12.0 wt % and the starch concentration is of 0.1 wt % to 12.0 wt % based on the overall weight of the multi ply pulp product. The process includes a step where the nanocellulose and the starch are combined to form a blend prior to mixing it with the starting pulp. The said mixture is then converted into single ply pulp intermediate layer. Alternatively, the process Includes a step of combining the nanocellulose, starch and starting pulp into a mixture prior to converting the said mixture into single ply pulp intermediate layer. To produce the multi ply pulp product, at least two single ply pulp intermediate layers are joined to each other mechanically, adhesively or a combination thereof.

In an embodiment, the present invention relates to a multi ply pulp product comprising of a starting pulp, nanocellulose and starch wherein the nanocellulose concentration is of 0.1 wt % to 12.0 wt % and the starch concentration is of 0.1 wt % to 12.0 wt % based on the overall weight of the multi ply pulp product and the process of producing thereof. The process produced single ply pulp intermediate layers and at least two single ply pulp intermediate layers are joined to each other mechanically, adhesively or a combination thereof. The multi ply pulp product is in the form of a paperboard or tissue sheet, core, a tube, a panel or any other structural surface or product thereof.

In an embodiment, the present invention relates to a multi ply pulp product having at least two single ply pulp intermediate layers joined to each other using an adhesive wherein the single ply pulp intermediate layers product has a nanocellulose concentration of 0.1 wt % to 12.0 wt % and a starch concentration of 0.1 wt % to 12.0 wt % based on the overall weight of the multi ply pulp product and wherein the adhesive has a nanocellulose concentration of 0.1 wt % to 12.0 wt % and a starch concentration of 0.1 wt % to 12.0 wt % based on the overall weight of the adhesive.

The nanocellulose that is provided in these embodiments of the invention is cellulose nanofibrils that are derived from various biomass resources or feedstock including, but are not limited to, hardwoods, softwoods, forest residues, agricultural products and residues, industrial wastes, consumer wastes or any other combinations thereof. In an embodiment, the cellulose nanofibrils are derived from lignocellulosic biomass such as empty fruit bunches of oil palm. The nanocellulose are preferably cellulose nanofibrils which have a length between 100 nanometers to 100 000 nanometers, preferably from 100 nanometers to 10 000 nanometers.

The nanocellulose may be obtained via a method of fractionation of lignocellulosic biomass in the presence of an acid catalyst, a solvent and water. The process comprises the step of providing lignocellulosic biomass and fractionating the lignocellulosic biomass in the presence of an acid, a solvent for lignin and water to produce solids rich in cellulose and liquid containing hemicellulose and lignin. The produced solids are then further processed via mechanical refining or through other methods such as enzymatic hydrolysis to obtain the cellulose nanofibrils. The cellulose nanofibrils are then recovered for further processing.

The mechanical refining step may include various techniques such as, but are not limited to, refining, grinding, milling, sonication or any other means or techniques which will allow cellulose nanofibrils to be obtained from the cellulose rich solids.

The acid catalyst for size reduction may include, but is not limited to, enzymes, sulfur dioxide, sulfurous acid, sulfuric acid, lignosulfonic acid or any other combinations or derivatives thereof. The process may further include a step of bleaching the solids rich in cellulose prior to the mechanical refining step or as part of the refining step. The process may further include a step of bleaching the nanocellulose during or after the mechanical refining step.

The nanocellulose may also be obtained via steam or hot-water extraction method wherein the process comprises the step of providing lignocellulosic biomass (or feedstock) and digesting the lignocellulosic biomass in the presence of steam or/and hot water to extract the hemicellulose into the liquid phase. The extracted solids may be washed with water at a pH of 7 or less to generate a filtrate and washed solids. The process may further include an optional step of separating some of the liquid phase from the extracted solids prior to washing the extracted solids with water.

Starch is mainly classified into two types i.e. native starch and modified starch. Native starches are derived from plants containing starch including tapioca, maize, rice, wheat and potato. Modified starches are native starches that have been modified physically, chemically and enzymatically and are known as amphoteric starch, cationic starch, oxidized starch and many more. In the present Invention, both native starch and modified starch may be used and are processed prior to use. The starch used in the present invention may include tapioca starch, amphoteric starch, cationic starch and any other suitable starches or a combination thereof.

For example, if native starch is used, the starch will typically be mixed with water at 2 to 30% solids and the mixture slurry heated until the starch has been dissolved and a uniformed gelation is produced. This process is known in the industry as starch “cooking”. For some applications, enzymes are added to the mixture before heating to reduce the viscosity of the gel. For some applications, such as in paperboard ply bond adhesive applications, the native starch Is not cooked, but applied in granular form and cooked in situ during paper drying.

Once the nanocellulose and starch are prepared and provided, the nanocellulose is then mixed with the starch to obtain a nanocellulose and starch blend. The blend of nanocellulose and starch has a concentration of 0.1 wt % to 12.0 wt % respectively based on the overall weight of the composition. The mixture will be used as an adhesive to secure the layers of the single ply intermediate pulp layers between each other by applying the adhesive on the surface of the handsheet and joining the coated surface together. The joined handsheets are then further processed, including drying, into a multi-ply product.

The nanocellulose and cooked starch may be added to the starting pulp to produce the pulp composition and subsequently converted into various single pulp products. Alternatively, the nanocellulose is added to the cooked starch to produce a nanocellulose and starch blend prior to adding the blend to the starting pulp. The starting pulp, nanocellulose and starch mixture is subsequently converted into an intermediate single ply pulp layer. The starch and nanocellulose are very similar but distinct polymers that have affinity for one another but that have not been purposefully chemically bonded to each other via chemical reaction when combined. The starch and nanocellulose assist in forming cross linkages with the fibres of the starting pulp to enhance the mechanical properties such as the strength of the pulp composition and its products.

A multi ply pulp product can be formed by bonding at least two intermediate layers of pulp product that are bonded to each other adhesively, mechanically or a combination thereof using the adhesive as described above. The multi ply pulp product may also consist of multi single ply pulp product that are bonded to each other. The multi ply pulp product may be in the form of a paperboard or tissue sheet, a core, a tube, a panel or any other structural surface or product thereof.

### EXEMPLARY EMBODIMENT FOR THE MULTI PLY PULP PRODUCT

The above description will enable one skilled in the art to make and use the invention, and it describes several embodiments, changes, adaptations, variations, alternatives, modifications and uses of the invention. These and other embodiments, features, and advantages of the present invention will become more apparent to those skilled in the art when taken with reference to the following detailed description of the invention in conjunction with any accompanying drawings.

In an exemplary embodiment of the present Invention, the process is provided with 1 kilogram (oven dry basis) coreboard pulp stock from a paperboard mill's machine chest and having a 3.5% consistency prior to adding any papermaking additives. The nanocellulose component is obtained from empty fruit bunches via hot- water extraction and mechanical refining. The starch component for addition as a wet-end strength additive is cooked prior to use or application. Cationic starch is mixed with distilled water at 2.5% to solids to form a slurry. The starch and distilled water slurry are stirred continuously in a water bath having a temperature of 100° C. with a loose-fitting lid until the solids are dissolved and a transparent, uniformed gelation is formed,

Once the nanocellulose and starch are prepared and provided, the nanocellulose is then mixed with the cooked starch. The mixture of nanocellulose and starch has a concentration of 1.0% with 0.25% nanocellulose and 0.75% cationic starch. The nanocellulose and starch mixture are first added into the coreboard pulp and agitated to obtain a homogenous mixture. Handsheets are then prepared from this mixture at a basis weight of 80 g/m² according to Technical Association of the Pulp and Paper Industry (TAPPI) Handsheets Forming Method T 205 sp-02 for physical testing.

As for the adhesive, the nanocellulose component is obtained from empty fruit bunches or oil palm using methods as described in the description or any other suitable methods that will yield the desired nanocellulose. The native, uncooked starch is provided as a dry powder.

Nanocellulose and uncooked starch were mixed together using a paddle mixer and diluted with water to obtain a slurry with a concentration of 3.0 wt % with 0.5% nanocellulose and 0.5% uncooked tapioca starch. In some embodiments, this mixture will be used as a spray adhesive to bind the layers of the coreboard paper.

Two single ply handsheets are prepared and the surfaces of handsheets are coated with the adhesive of nanocellulose and starch blend using a spray mist. The two-single ply handsheets were joined at the coated surfaces, pressed, dried at 100 *C in a lab paper drier and conditioned according to Technical Association of the Pulp and Paper Industry (TAPPI) Handsheets Forming Method T 205 for physical testing.

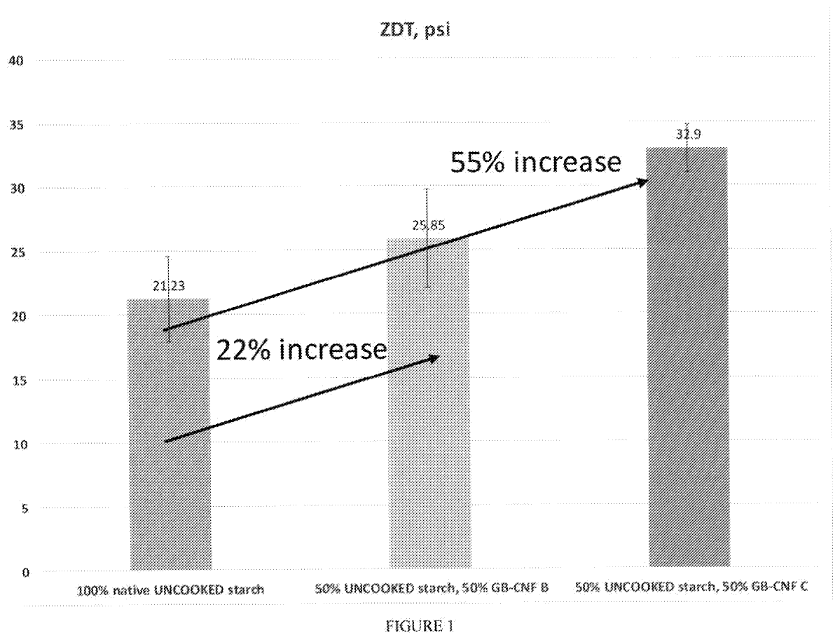

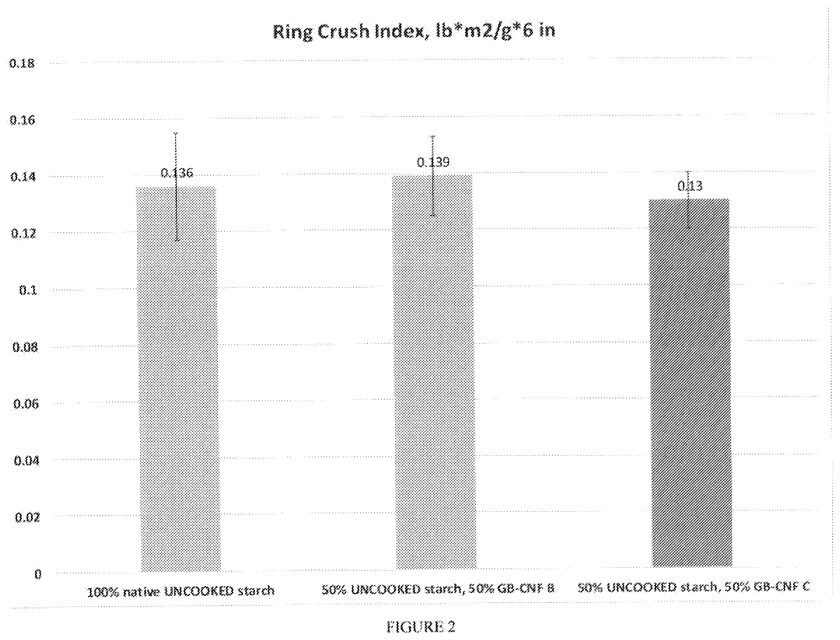

With reference to FIGS. 1 and 2, the starch and nanocellulose spray adhesive applied at 0.5% nanocellulose and 0.5% uncooked native starch between two wet formed pulp layers to form a two-ply handsheet, provides up to 55% increase in Z-Directional Tensile (ZDT), a measure of ply bond, as 1% uncooked native starch that is conventionally used, with no negative impact on Ring Crush. As such, the coreboard mill can obtain higher ply bonding strength than starch alone or obtain cost reductions by reducing the amount of spray adhesive used between plies for a given ply bond target. The result suggests a heretofore unknown synergy between high bonding starch and high aspect ratio nanocellulose for improving ply bond strength. The above description will enable one skilled in the art to make and use the invention, and it describes several embodiments, changes, adaptations, variations, alternatives, modifications and uses of the Invention. These and other embodiments, features, and advantages of the present invention will become more apparent to those skilled in the art when taken with reference to the detailed description of the invention in conjunction with any accompanying drawings.

1.-97. (canceled)

98. A process of producing a multi ply pulp product having at least two single ply pulp products joined to each other using an adhesive, wherein the process includes the steps of:
a. preparing at least a first single ply pulp product and a second single ply pulp product by combining a starting pulp and a first mixture of nanocellulose and starch;
b. preparing the adhesive by mixing a second mixture of nanocellulose and starch;
c. interposing the adhesive between the first single ply pulp product and the second single ply pulp product; and
d. joining the first and second single ply pulp products containing the adhesive interposed there between, producing a multi ply pulp product;
wherein the nanocellulose and starch concentrations in the multi ply pulp product has an overall weight of 0.1 wt % to 12.0 wt % each, and
wherein the nanocellulose and starch concentrations in the adhesive in step b has an overall weight of 0.1 wt % to 12.0 wt % each.

99. The process as claimed in claim 98 wherein the at least two single ply pulp products are joined to each other mechanically, adhesively or a combination thereof.

100. The process as claimed in claim 98 wherein the first and second mixtures of nanocellulose have concentrations of 0.3 wt % to 3.0 wt % and the starch has concentration of 0.3 wt % to 3.0 wt %.

101. The process as claimed in claim 98 wherein the first and second mixtures of nanocellulose have concentrations of 0.5 wt % to 2.0 wt % and the starch has concentration of 0.5 wt % to 2.0 wt %.

102. The process as claimed in claim 98 wherein the first and second mixtures of nanocellulose have concentrations of less than 2.0 wt % and the starch has concentration of 2.0 wt %.

103. The process as claimed in claim 98 wherein the nanocellulose is obtained from biomass resources namely empty fruit bunches of oil palm, agricultural residues, softwoods, hardwoods or a combination thereof.

104. The process as claimed in claim 98 wherein the starch in the first and second mixtures is tapioca starch, cationic starch, amphoteric starch or a combination thereof.

105. The process as claimed in claim 98 wherein the multi ply pulp product is in the form of a core, a tube, a panel or any other structural surface or product thereof.

106. The process as claimed in claim 98 wherein the starch in step a is a cooked starch is preferred.

107. The process as claimed in claim 99 wherein the starch in step b is an uncooked starch wherein the uncooked starch is in a powdery form.

108. The process as claimed in claim 98 wherein nanocellulose is cellulose nanofibrils.

109. The process as claimed in claim 108 wherein the size of the cellulose nanofibrils is between 100 nanometers to 100,000 nanometers.

110. The process as claimed in claim 98 wherein the nanocellulose in the first and second mixtures is bleached is preferred.

111. The process as claimed in claim 98 wherein the nanocellulose in the first and second mixtures is unbleached is also preferred.

112. The process as claimed in claim 98 wherein the starch is a native starch such as tapioca starch or a modified starch such as cationic starch, amphoteric starch or a combination thereof.
